(19) United States
(12) Patent Application Publication
(10) Pub. No.: US 2025/0015378 A1
(43) Pub. Date: Jan. 9, 2025

(54) RECYCLING METHODS FOR LITHIUM-ION BATTERIES

(71) Applicant: THE REGENTS OF THE UNIVERSITY OF CALIFORNIA, Oaklnd, CA (US)

(72) Inventors: Juchen Guo, Anaheim, CA (US); Jiayan Shi, Shantin New Town (HK); Jian Zhang, Riverside, CA (US); Nastaran Shojarazavi, Riverside, CA (US)

(21) Appl. No.: 18/711,568

(22) PCT Filed: Oct. 28, 2022
(86) PCT No.: PCT/US2022/048270

§ 371 Date: May 17, 2024

Related U.S. Application Data
(60) Provisional application No. 63/281,424, filed on Nov. 19, 2021.

(51) Int. Cl. H01M 10/54; C22B 3/00; C22B 7/00; C22B 26/12

(52) U.S. Cl. CPC H01M 10/54; C22B 7/006; C22B 23/04; C22B 26/12

(57) ABSTRACT

Various examples disclosed relate to methods for recycling lithium-ion battery cathode materials. The present disclosure includes methods that use ionic liquids, such as containing tetrachloroaluminate anions, or organic solutions of aluminum chloride, for recycling.

### CROSS-REFERENCE TO RELATED APPLICATION

This application claims the benefit of priority to U.S. Provisional Patent Application Ser. No. 63/281,424 entitled “CYCLING METHODS FOR LI-ION BATTERIES ENABLED BY LEWIS NEUTRAL CHLOROALUMINATE ANION ALCL₄₋,” filed Nov. 19, 2021, the disclosure of which is incorporated herein in its entirety by reference.

### STATEMENT OF GOVERNMENT SUPPORT

This invention was made with Government support under W912HQ21C0011 awarded by Department of Defense Strategic Environmental Research Development. The U.S. Government has certain rights in this invention.

### BACKGROUND

Lithium-ion batteries (LIBs) are a popular portable power sources due to their high specific capacity, high power density, and long cyclability. With the rapid development of technologies, the usage of LIBs has increased drastically making their recycling an urgent demand, both economically and environmentally.

The Net-Zero Transition is a vital initiative for the future of planet Earth. This grand scheme has several subbranches including air pollution and solid waste management, and reduction in energy usage. The emersion of electric vehicles (EVs) and their improvement foretell an effective route for addressing the aforementioned issues. The international energy agency (IEA) has recently published a report that gives a detailed worldwide outlook for the EVs demand growth, showing that sales have increased from 120,000 cars globally in 2012 to 2 million sold vehicles in the first quarter of 2022. The total number of EVs have been also projected to reach 21 million by the end of 2030.

However, the battery cell constituents play a key role in these rechargeable power sources which is a bottleneck due to the limited global resources of these components. In particular, Cobalt (Co) which is used in high-energy cathode materials for EVs is forecasted to become a restraint in the LIBs supply chain. According to the US Geological Survey (USGS), 7.6 million metric tons is an estimation of the proven cobalt reserves worldwide. In addition to the disproportionate distribution of these reserves, the electrification of the automotive industry is continuously increasing the demand for this transition metal, an estimated amount of 117,000 metric tons by the year 2025.

### SUMMARY OF THE DISCLOSURE

The present disclosure provides strategies for recycling lithium-ion battery cathode materials, such as lithium cobalt oxide (LiCoO₂), lithium nickel manganese cobalt oxide (LiNiₓMn_{y}Co_{1-x-y}O₂) and any related materials containing lithium transition metal oxides, using chloroaluminate ionic liquids containing tetrachloroaluminate anions (AlCl₄⁻) or aluminum chloride (AlCl₃) solution on organic solvents.

In the case of improper recycling of LIBs, electrolyte reaction with water could produce dangerous gases while heavy metals in the cathode such as Co, nickel (Ni), or manganese (Mn) could cause serious contamination in the soil or underground water. Thus, it is important to recycle these battery materials before facing a significant shortage or environmental challenge in the near future. Some industrial recycling methods start with a pretreatment step to boost efficiency and separate some parts of the battery waste with distinct physical properties. After pretreatment (chemical, mechanical, thermal treatment, or other) the battery waste stream may be ready for different processing routes. Many sites utilize a pyrometallurgical method. Despite the high recycling efficiency for valuable metals such as Co, Ni, or Cu, this method is not able to recycle lithium as it escapes in the forms of oxides and gases or remains unrecoverable as slag. Moreover, the nature of this process is thermally aggressive and consequently requires high energy consumption. Another commercialized recycling route is hydrometallurgy where organic or inorganic acid solutions are employed to leach valuable cathode materials as ions providing high recycling efficiency using relatively low energy. However, the problem lies in the fact that corrosive reagents are harmful to both environment and the working personnel

In comparison, where chloroaluminate ionic liquids or AlCl₃ solution in organic solvents act as the reaction medium, a greener and much safer alternative to acids, is provided.

In an example, tetrachloroaluminate anion (AlCl₄⁻), present in a room temperature ionic liquid composed of 1:1 molar ratio of 1-ethyl-3-methylimidazolium chloride (EMIMCl) and aluminum chloride (AlCl₃), can effectively extract lithium (Li) and cobalt (Co) from lithium cobalt oxide (LiCoO₂) cathode in spent Li-ion batteries. Experimental analyses indicate that the strong affinity between AlCl₄⁻ and LiCoO₂ can enable the extraction of lithium from LiCoO₂ to form lithium chloride (LiCl). As a result, Co(III) in LiCoO₂ is reduced to Co(II) by the oxide and oxygen gas is generated. UV-Vis and X-ray photoelectron spectroscopic (XPS) analyses show that Co(II) can exist as cobalt tetrachloride (CoCl₄²⁻) anion. AlCl₄⁻ is transferred to an amorphous compound composed of aluminum oxide and chloride (aluminum oxychloride). The extraction efficiency of lithium and cobalt both reach 100%, and 99.4% of the Al content (as AlCl₄⁻) can be removed by converting aluminum oxychloride to Al oxide followed by water rinse. cobalt can be subsequently recovered as cobalt hydroxide (Co(OH)₂) at a 99.7% recovery rate.

In another example, solutions of aluminum chloride (AlCl₃) in organic solvents, represented by ethanol, can effectively extract lithium (Li), cobalt (Co), nickel (Ni), and manganese (Mn) from lithium cobalt oxide (LiCoO₂) and LiNi_{0.6}Mn_{0.2}Co_{0.2}O₂ cathodes in spent Li-ion batteries. Specifically, AlCl₃ solution in ethanol can quickly dissolve LiCoO₂ and LiNi_{0.6}Mn_{0.2}Co_{0.2}O₂ cathode under mild heating condition. UV-vis spectroscopic analysis indicates the transition metal (Co, Ni, and Mn) tetrachloride anions are formed in the solution, and evaporating ethanol results to solid products including lithium chloride, transition metal chlorides, and amorphous compound containing Al. The Al-containing compound can be converted to aluminum oxide that is insoluble in water by mild heat treatment at 150° C. and subsequently removed by rinsing with water. The resultant aqueous solution can contain 99.5% of the transition metal extracted from the cathode materials.

These various example methodologies of using chloroaluminate ionic liquids and AlCl₃ solutions in organic solvents to recycle lithium-ion batteries can have a number of advantages and benefits by avoiding other techniques. These methods can allow for low emissions, low energy consumption, clean extraction of transition metals such as cobalt, from lithium-ion battery cathode materials.

In an example, a method of recycling a lithium-ion battery cathode material can include reducing the lithium-ion battery cathode material with an ionic liquid including chloroaluminate anion and separating materials from the lithium-ion battery cathode.

In another example, a method of recycling a lithium-ion battery cathode material can include reducing the lithium-ion battery cathode material with an organic solution of AlCl₃ and separating materials from the lithium-ion battery cathode.

### BRIEF DESCRIPTION OF THE FIGURES

The patent or application file contains at least one drawing executed in color. Copies of this patent or patent application publication with color drawing(s) will be provided by the Office upon request and payment of the necessary fee.

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various examples discussed in the present document.

FIG. 1 illustrates XRD data of lithium-ion battery cathode recycling in an example.

FIG. 2 illustrates UV-Vis data of lithium-ion battery cathode recycling in an example.

FIG. 3 illustrates NMR data of lithium-ion battery cathode recycling in an example.

FIG. 4 illustrates XRD data of lithium-ion battery cathode recycling in an example.

FIG. 5 illustrates XPS data of lithium-ion battery cathode recycling in an example.

FIG. 6 illustrates NMR data of lithium-ion battery cathode recycling in an example.

FIG. 7 illustrates UV-Vis data of lithium-ion battery cathode recycling in an example.

FIG. 8 illustrates UV-Vis data of lithium-ion battery cathode recycling in an example.

FIG. 9 illustrates XRD data of lithium-ion battery cathode recycling in an example.

FIG. 10 illustrates XRD data of lithium-ion battery cathode recycling in an example.

FIG. 11 illustrates NMR data of lithium-ion battery cathode recycling in an example.

### DETAILED DESCRIPTION

Reference will now be made in detail to certain examples of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

### Definitions

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

The term “organic group” as used herein refers to any carbon-containing functional group. Examples can include an oxygen-containing group such as an alkoxy group, aryloxy group, aralkyloxy group, oxo(carbonyl) group; a carboxyl group including a carboxylic acid, carboxylate, and a carboxylate ester; a sulfur-containing group such as an alkyl and aryl sulfide group; and other heteroatom-containing groups. Non-limiting examples of organic groups include OR, OOR, OC(O)N(R)₂, CN, CF₃, OCF₃, R, C(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, C(═NOR)R, and substituted or unsubstituted (C₁-C₁₀₀)hydrocarbyl, wherein R can be hydrogen (in examples that include other carbon atoms) or a carbon-based moiety, and wherein the carbon-based moiety can be substituted or unsubstituted.

The term “substituted” as used herein in conjunction with a molecule or an organic group as defined herein refers to the state in which one or more hydrogen atoms contained therein are replaced by one or more non-hydrogen atoms. The term “functional group” or “substituent” as used herein refers to a group that can be or is substituted onto a molecule or onto an organic group. Examples of substituents or functional groups include, but are not limited to, a halogen (e.g., F, Cl, Br, and I); an oxygen atom in groups such as hydroxy groups, alkoxy groups, aryloxy groups, aralkyloxy groups, oxo(carbonyl) groups, carboxyl groups including carboxylic acids, carboxylates, and carboxylate esters; a sulfur atom in groups such as thiol groups, alkyl and aryl sulfide groups, sulfoxide groups, sulfone groups, sulfonyl groups, and sulfonamide groups; a nitrogen atom in groups such as amines, hydroxyamines, nitriles, nitro groups, N-oxides, hydrazides, azides, and enamines; and other heteroatoms in various other groups. Non-limiting examples of substituents that can be bonded to a substituted carbon (or other) atom include F, Cl, Br, I, OR, OC(O)N(R)₂, CN, NO, NO₂, ONO₂, azido, CF₃, OCF₃, R, O (oxo), S (thiono), C(O), S(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, and C(═NOR)R, wherein R can be hydrogen or a carbon-based moiety; for example, R can be hydrogen, (C₁-C₁₀₀)hydrocarbyl, alkyl, acyl, cycloalkyl, aryl, aralkyl, heterocyclyl, heteroaryl, or heteroarylalkyl; or wherein two R groups bonded to a nitrogen atom or to adjacent nitrogen atoms can together with the nitrogen atom or atoms form a heterocyclyl.

The term “deplete” as used herein refers to decreasing in quantity or concentration, such as of a liquid, gas, or solute. For example, a mixture of gases A and B can be depleted in gas B if the concentration or quantity of gas B is decreased, for example by selective permeation of gas B through a membrane to take gas B away from the mixture, or for example by selective permeation of gas A through a membrane to add gas A to the mixture.

The term “solvent” as used herein refers to a liquid that can dissolve a solid, liquid, or gas. Non-limiting examples of solvents are silicones, organic compounds, water, alcohols, ionic liquids, and supercritical fluids.

The term “room temperature” as used herein refers to a temperature of about 15° C. to 28° C.

The term “standard temperature and pressure” as used herein refers to 20° C. and 101 kPa.

In various examples, salts having a positively charged counterion can include any suitable positively charged counterion. For example, the counterion can be ammonium (NH₄⁺), or an alkali metal such as sodium (Na⁺), potassium (K⁺), or lithium (Li⁺). In some examples, the counterion can have a positive charge greater than +1, which can in some examples complex to multiple ionized groups, such as Zn²⁺, Al³⁺, or alkaline earth metals such as Ca²⁺ or Mg²⁺.

In various examples, salts having a negatively charged counterion can include any suitable negatively charged counterion. For example, the counterion can be a halide, such as fluoride, chloride, iodide, or bromide. In other examples, the counterion can be nitrate, hydrogen sulfate, dihydrogen phosphate, bicarbonate, nitrite, perchlorate, iodate, chlorate, bromate, chlorite, hypochlorite, hypobromite, cyanide, amide, cyanate, hydroxide, permanganate. The counterion can be a conjugate base of any carboxylic acid, such as acetate or formate. In some examples, a counterion can have a negative charge greater than −1, which can in some examples complex to multiple ionized groups, such as oxide, sulfide, nitride, arsenate, phosphate, arsenite, hydrogen phosphate, sulfate, thiosulfate, sulfite, carbonate, chromate, dichromate, peroxide, or oxalate.

### Reaction Mechanisms

In an example method, lithium metal oxide cathodes such as LiCoO₂, LiNiₓMn_{y}Co_{1-x-y}O₂, and any other containing transition metals can be recycled by deep eutectic systems containing AlCl₄⁻ anion, not limited to the presented EMIMAlCl₄ ionic liquid. Any deep eutectic system or ionic liquid containing AlCl₄₋ may work. The EMIMAlCl₄ ionic liquid is a mixture of aluminum chloride (AlCl₃) and 1-ethyl-3-methylimidazolium aluminum chloride (EMIMCl) at 1:1 molar ratio, and composed of EMIM⁺ cation and tetrachloroaluminate anion (AlCl₄⁻) according to the following reaction:

EMIMCl+AlCl₃→EMIM⁺+AlCl₄⁻

Based on the elemental ratio obtained from experimentation and the identification of products including LiCl, CoCl₄²⁻, and O₂, lithium may be extracted from the crystal lattice of LiCoO₂ by the strong affinity with Cl⁻ in AlCl₄⁻ anion. Or oxygen vacancy in LiCoO₂ is created by the strong affinity between Al cation and oxide. As a result, Co(III) is reduced to Co(II) by the oxide in LiCoO₂ and oxygen gas may be released. The example reaction mechanisms between LiCoO₂ and AlCl₄⁻ may be as follows:

2AlCl₄⁻+LiCoO₂→LiCl+CoCl₄²⁻+¼O₂+½Al₄O₃Cl₆

### OR

2AlCl₄⁻+LiCoO₂→LiCl+CoCl₄²⁻+¼O₂+½AlCl₃+ 3/2AlOCl

The proposed compound Al₄Cl₆O₃ from the low LiCoO₂/AlCl₄⁻ ratio reaction is amorphous and a stoichiometric combination of the more distinct compounds of AlCl₃ and aluminum oxychloride (AlOCl) from the reaction with high LiCoO₂/AlCl₄⁻ ratio.

This demonstrates a method to extract lithium and cobalt from LiCoO₂, and this method can be used to recycle spent Li-ion batteries. This method is based on a reaction between tetrachloroaluminate AlCl₄⁻ anion and LiCoO₂. A reagent containing AlCl₄⁻ anion can be used to extract lithium and transition metals from Li-ion batteries using lithium transition metal oxide cathodes including LiCoO₂, LiNiₓMn_{y}Co_{1-x-y}O₂, and related materials.

In other examples, a solution of AlCl₃ in organic solvent can be used as the recycling medium. Where an organic solvent, such as ethanol, is used in preparation of the solution, the following reaction mechanisms may occur:

2AlCl₂⁺+2LiCoO₂+CH₃CH₂OH →2Li⁺+2Co²⁺+4Cl⁻+Al₂O₃+CH₃COH+H₂O

### OR

2AlCl²⁺+2LiCoO₂+CH₃CH₂OH →2Li⁺+2Co²⁺+2Cl⁻+Al₂O₃+CH₃COH+H₂O

Here, AlCl₂ ⁺ and AlCl²⁺ are aluminum-chloride complex cations and the representative active species in the AlCl₃ solution in ethanol (EtOH—AlCl₃) that can react to LiCoO₂. These reaction mechanisms are supported and discussed with reference to the Examples section below.

### Methods

In an example, a method of recycling a lithium-ion battery cathode material, the method comprising reducing the lithium-ion battery cathode material with an liquid including chloroaluminate ionic liquids or AlCl₃ solutions in organic solvents and separating materials from the lithium-ion battery cathode.

The chloroaluminate ionic liquid can contain Lewis neutral chloroaluminate anions (AlCl₄⁻) or Lewis acidic chloroaluminate anions (Al₂Cl₇⁻

The AlCl₃ solution in organic solvents can contain chloroaluminate anions, chloride anions, and aluminum-chloride complex cations.

The lithium-ion battery cathode material can include any Li-ion battery cathode material containing lithium and transition metals. The lithium-ion battery cathode material can include, for example, Lithium cobalt oxide (LCO), Lithium nickel cobalt aluminum oxide (NCA), Lithium manganese oxide (LMO), Lithium iron phosphate (LFP), Lithium nickel manganese cobalt oxide —LiNi(1-y-z)Mn(y)Co(z)O2(NMC), or combinations thereof.

Reducing the lithium-ion battery cathode material can include, for example, adding 1-Ethyl-3-methylimidazolium tetrachloroaluminate ionic liquid to the lithium-ion battery cathode material or adding tetrachloroaluminate ionic liquid to the lithium-ion battery cathode material.

Adding tetrachloroaluminate ionic liquid to the cobalt (or other transition metal) in the lithium-ion battery cathode material can be down at a 1:20 molar ratio, at a 1:10 molar ratio, at a 1:5 molar ratio, or at a 1:2 molar ratio.

In some cases, reducing the lithium-ion battery cathode material comprises adding EtOH—AlCl₃ solution to the lithium-ion battery cathode material.

Separating materials from the lithium-ion battery cathode comprises separating and removing cobalt from the lithium-ion battery cathode or separating and removing lithium from the lithium-ion battery cathode. In some cases, separating materials from the lithium-ion battery cathode can include centrifuge. In some cases, separating materials from the lithium-ion battery cathode can include extracting cobalt and other transition metals as a cation.

Separating materials from the lithium-ion battery cathode can include extracting cathode active materials, such as with no emissions, such as at room temperature.

Preparing the ionic liquid can include chloroaluminate anion prior to reducing the lithium-ion battery cathode material. Preparing the ionic liquid comprises can include mixing AlCl₃ in EMIMCl with a molar ratio of 1:1. In some cases, preparing the ionic liquid can include gradually adding anhydrous AlCl₃ powder to EMIMCl.

Preparing the AlCl₃ solution inorganic solvents can include adding anhydrous AlCl₃ to ethanol.

### Examples

Various examples of the present disclosure can be better understood by reference to the following Examples which are offered by way of illustration. The present disclosure is not limited to the Examples given herein.

### Example 1. Extraction of Lithium and Cobalt from LiCoO₂ Cathode via an Ionic Liquid Containing Tetrachloroaluminate Anion (AlCl₄⁻)

In Example 1, lithium-ion battery cathode materials were recycled through extraction of lithium and cobalt using ionic liquids containing tetrachloroaluminate anion. In Example 1, reactivity of LiCoO₂ with an EMIMAlCl₄ ionic liquid was tested.

First, a reaction of LiCoO₂ with EMIMAlCl₄ was performed. A 1-Ethyl-3-methylimidazolium tetrachloroaluminate (EMIMAlCl₄) ionic liquid was prepared by slowly mixing AlCl₃ (AlCl₃, anhydrous, 99.99%, Sigma-Aldrich) in 1-Ethyl-3-methylimidazolium Chloride (EMIMCl) (>98%, HPLC, TCI Chemicals) with molar ratio 1:1 (EMIMCl: AlCl₃), then stirring for 12 hours at room temperature before use. 1-Ethyl-3-methylimidazolium Chloride (EMIMCl) (>98%, HPLC, TCI Chemicals) was dried under vacuum inside glovebox at 60° C. for 12 hours before use.

After preparing the EMIMAlCl₄ ionic liquid, Lithium cobalt oxide (LiCoO₂, 99.8% trace metal basis, Sigma-Aldrich) powder was added with different LiCoO₂: EMIMIAlCl₄ molar ratios (1:20, 1:10, 1:5, and 1:2), then stir for 12 hours at 150° C. The reactor flask is equipped with a condenser on top with water circulating at 10° C. It appears that LiCoO₂ dissolves in EMIMAlCl₄ and the reaction produces a blue solution and white solid precipitate. Generation of oxygen was detected by Dissolved Oxygen Kit (Atlas Scientific).

For reactions with LiCoO₂/AlCl₄⁻ molar ratios at 1:20, 1:10, and 1:5, the supernatant and the precipitate after the reaction were separated by centrifuge at 20,000 g for 5 min for further analysis.

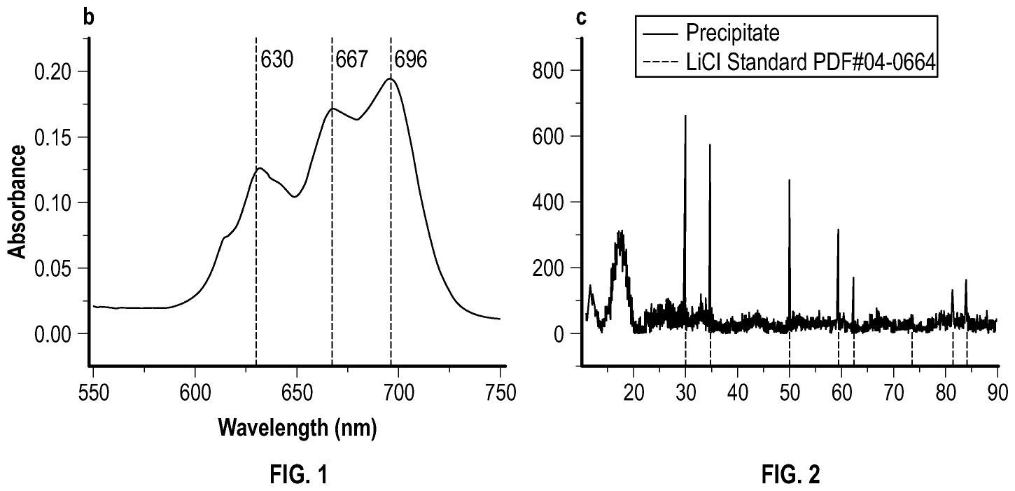

X-ray powder diffraction measurement (XRD) was conducted with Panalytical Empyrean Series 2 to analyze the precipitate. The precipitate was washed with benzene three times and then dried inside a glovebox filled with argon gas at room temperature for 24 h. subsequently, the dried powder was pressed to form a pallet on a zero-diffraction silicon plate then the surface was covered with Kapton tape film to prevent the sample's reaction with air and avoiding moisture absorption. XRD measurement was then conducted. The XRD pattern in FIG. 1 indicates that precipitate contains lithium chloride (LiCl).

Agilent Cary 60 UV-Vis spectrophotometer was used to analyze the Co species in the supernatant. 3 ml of the supernatant liquid diluted with the EMIMAlCl₄ ionic liquid was inserted into a 10×10 mm quartz cuvette and sealed with a cap. Baseline measurement were taken on the EMIMAlCl₄ ionic liquid alone in the same cuvette in the range of 550 to 750 nm. FIG. 2 depicts the UV-Vis spectrum of the supernatant after the reaction. The identifiable peaks at 630, 667, and 696 nm are indexed to cobalt tetrachloride anions (CoCl₄²⁻)

Liquid state Nuclear Magnetic Resonance (NMR) was also performed on the supernatant. Liquid state NMR spectra (²⁷Al and ¹H) were acquired by Bruker Avance 600 spectrometer with a 14.1 T narrow bore superconducting magnet operating at 104.26 and 600.13 MHz for 27Al and 1H nuclei, respectively. To avoid mixing samples with the standard solution, a double-tube assembly was used where the sample was sealed inside a 5 mm NMR tube with the standard chloroform-d in a 3 mm NMR tube inserted inside the larger tube (with a Sample: Standard volume ratio of 2:3). All liquid-state ²⁷Al and ¹H experiments were conducted with radio frequency field strengths of 20.8 kHz and 26 kHz, respectively and with a recycle delay of 12.0 s when all the spins relaxed back to the thermal equilibrium. ²⁷Al and ¹H NMR were conducted at 110° C. and 25° C., respectively.

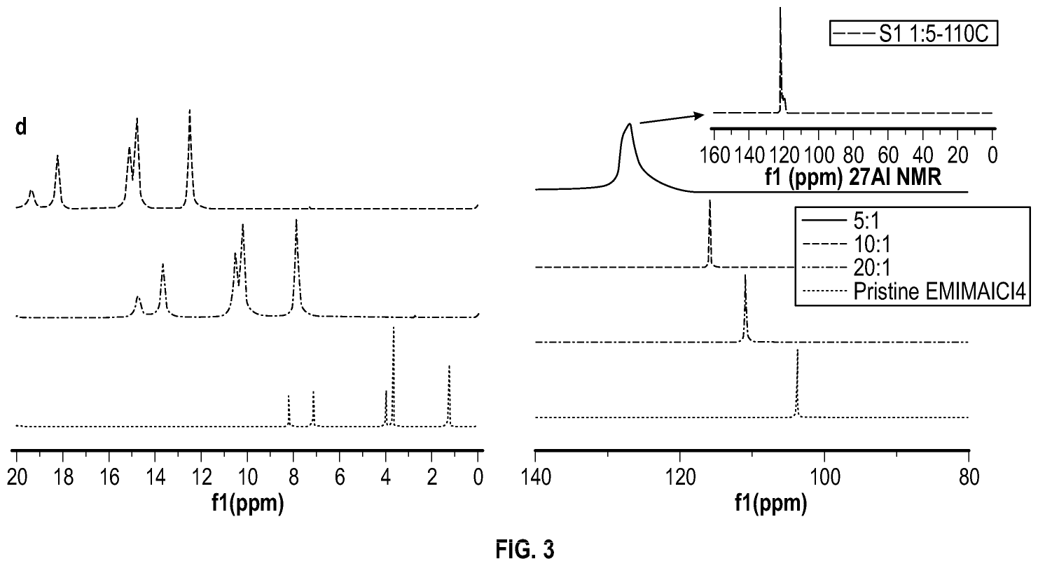

Comparing to the original EMIMAlCl₄, the ¹H nuclear magnetic resonance (NMR) spectra FIG. 3 of the supernatant after the reaction at different LiCoO₂/AlCl₄⁻ molar ratio indicate that the EMIM⁺ cation remains intact. The downfield chemical shift with the increasing LiCoO₂/AlCl₄⁻ molar ratio and the broadening of the peaks is due to the paramagnetic effect of Co²⁺. The ²⁷Al NMR spectrum of the pristine EMIMAlCl₄ shows a single peak at 104.1 ppm, which represents AlCl₄⁻ anion. Room temperature ²⁷Al NMR spectra of the supernatants after reactions with 1:20 and 1:10 LiCoO₂/AlCl₄⁻ molar ratios also only the AlCl₄⁻ peak, which suggests no soluble Al-containing species generated during the reaction. However, the²⁷Al NMR spectrum of the supernatant after reaction with 1:5 LiCoO₂/AlCl₄⁻ molar ratio shows a broader peak further shifted to downfield comparing to the ones from 1:20 and 1:10 ratio. A ²⁷Al NMR spectrum of the supernatant from the 1:5 LiCoO₂/AlCl₄⁻ molar ratio was obtained at 150° C. As displayed in the inset of FIG. 3, the spectrum shows two peaks that can be indexed as AlCl₄⁻ and a new anionic species Al₂Cl₇⁻, which is formed from the reaction between AlCl₄⁻ and AlCl₃ according to following reaction:

AlC₄⁻+AlCl₃→Al₂C₇⁻

Therefore, this result indicates that AlC₃ may be produced from the reaction with high LiCoO₂/AlCl₄⁻ molar ratio.

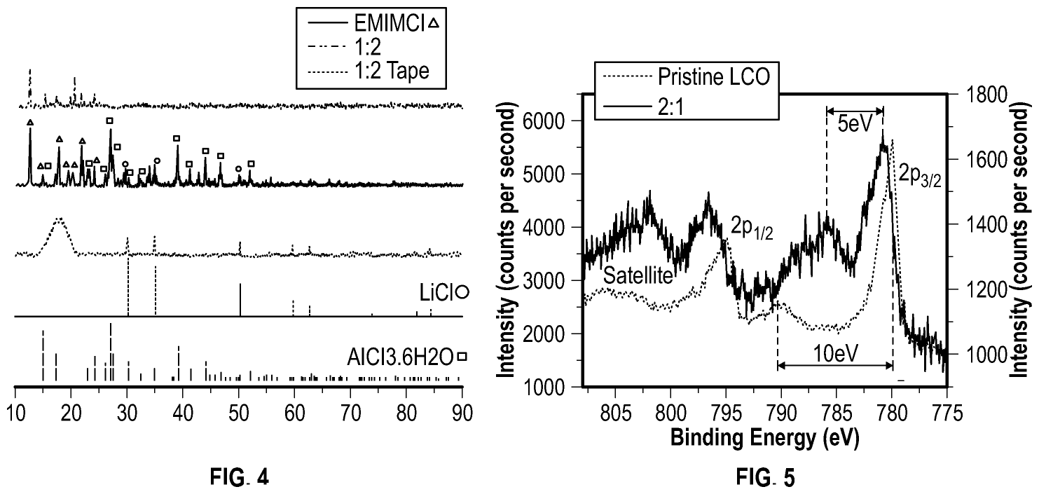

The reaction between LiCoO₂ and EMIMAlCl₄ ionic liquid with 1:2 molar ratio resulted to a paste-like product due to the high content of precipitate. This paste product is characterized by X-ray diffraction (XRD). The XRD patterns of the project in FIG. 4 shows pattern of LiCl when a Kapton tape was used to seal the sample to prevent contact from ambient environment. Once the tape was removed, the XRD pattern indicated the content of AlCl₃·6H₂O, in which the crystal water is likely absorbed from the environment. The XRD also indicate EMIMCl and CoCl₂.

Oxygen gas was identified in the reaction with the LiCoO₂: EMIMAlCl₄ molar ratio of 1:2. The reaction was sealed and closed inside a glovebox with O₂<0.01 ppm. When the reaction was complete, the valve connected to the reaction flask was opened while the exhaust relighted a dying match proving the presence of oxygen. This suggests that oxygen gas is generated from the reaction.

Based on the finding that LiCl, CoCl₄²⁻, and O₂ are three of the products, it is likely that lithium is extracted from the crystal lattice of LiCoO₂ by the strong affinity with Cl⁻ in AlCl₄⁻ anion. Or, oxygen vacancy is created due to the strong affinity between O²⁺ and Al³⁺. As a result, Co(III) is reduced to Co(II) by the oxide in LiCoO₂ and oxygen gas may be released.

Based on the above spectroscopic analyses, the reaction mechanisms between LiCoO₂ and AlCl₄⁻ are as follows:

2AlCl₄⁻+LiCoO₂→LiCl+CoCl₄²⁻+¼O₂+Al₄O₃Cl₆ at relatively low ratio of LiCoO₂/AlCl₄⁻

### OR

2AlCl₄⁻+LiCoO₂→LiCi+CoCl₄²⁻+¼O₂+AlCl₃+AlOCl at relatively high ratio of LiCoO₂/AlCl₄⁻

The compound Al₄Cl₆O₃ from the low LiCoO₂/AlCl₄⁻ ratio reaction is amorphous and a stoichiometric combination of the more distinct compounds of AlCl₃ and aluminum oxychloride (AlOCl) from the reaction with high LiCoO₂/AlCl₄⁻ ratio.

X-ray photoelectron spectroscopy (XPS) analysis was performed on the product from the reaction with 1:2 LiCoO₂/AlCl₄⁻ molar ratio. XPS data was collected using Kratos AXIS Supra (Al Kα=1486.7 eV) at UC Irvine Materials Research Institute (IMRI). The samples were transported to the XPS facility inside a stainless-steel tube with KF flange sealing filled with argon. The samples were loaded in the sample chamber in the glovebox integrated with Kratos AXIS Supra for XPS analysis. All peaks of XPS data were analyzed by Casa XPS52 and calibrated with the reference peak of C is at 284.6 eV (the adventitious carbon).

FIG. 5 shown the cobalt 2p X-ray photoelectron spectroscopic (XPS) spectra of the pristine LiCoO₂ and the product. The cobalt 2p spectrum of the pristine LiCoO₂ shows the binding energy difference between satellite of 2p 1/2 (790.4 eV) and 2p 1/2 (780 eV) is ˜10 eV, which indicates the valence of cobalt ion is 3+. For the cobalt 2p XPS spectrum of the product, there is distinguishable change of the binding energy difference between satellite of 2p 1/2 (785.8 eV) and 2p 1/2 (780.8 eV) is about 5 eV, which indicate the valence of cobalt ion in the product is 2+. The XPS spectra comparison clearly demonstrates that Co(III) in LiCoO₂ is converted to Co(II) in the reaction.

An additional demonstration of extraction of cobalt and lithium from battery materials was demonstrated with visual testing. The products from the reaction with the 1:2 LiCoO₂/AlCl₄⁻ molar ratio was completely soluble in water, resulting in a transparent solution with the characteristic pink color representing hydrated Co(II). White precipitate is generated when the water solution is stirred in ambient environment at 70° C. overnight. Inductively coupled plasma optical emission spectrometry (ICP-OES) analysis show the only metal content in the precipitate is Al, and the XRD demonstrates its amorphous nature. This is likely aluminum oxide (Al₂O₃) generated from the oxidization of AlOCl and Al₄O₃Cl₆. The water is evaporated from the solution after the precipitate is filtered out. The resulted blue power was further heated at 150° C. for overnight. The heated power was added into water, and a pink solution with white precipitate was the produced. The precipitate is Al₂O₃ converted from AlCl₃ by heating, and it is filtered out.

Inductively coupled plasma optical emission spectrometry (ICP-OES) was conducted on the samples including the final pink supernatant and the total precipitate. The amount of aluminum (Al), cobalt (Co), and lithium (Li) were determined by a Perkin-Elmer Optima 7300DV ICP-OES apparatus. The percentage of the metal in the supernatant and precipitate are listed in Table 1.

TABLE 1
Percentage of metals in the final products
after lithium and cobalt extraction.

| | Al (%) | cobalt (%) | lithium (%) |
|---|---|---|---|
| Supernatant | 0.39 ± 0.002 | 99.86 ± 0.52 | 36.16 ± 0.09 |
| Precipitate | 99.61 ± 0.39 | 0.14 ± 0.005 | 63.82 ± 0.46 |

The elemental analysis shows that 99.61% of the Al (from the AlCl₄⁻ anion) is removed as the precipitate (Al₂O₃); 99.86% of the cobalt was extracted in the aqueous solution as Co²⁺ cation. The aqueous solution also contains 36.16% of the total Li, and the rest of 63.82% of lithium exist in the precipitate.

This demonstrates a method to extract lithium and cobalt from LiCoO₂, and this method can be used to recycle spent Li-ion batteries. This method is based on a reaction between tetrachloroaluminate AlCl₄⁻ anion and LiCoO₂. Based on these results, it is likely that any reagent containing AlCl₄⁻ anion can be used to extract lithium and transition metals from Li-ion batteries using lithium transition metal oxide cathodes including LiCoO₂, LiNiₓMn_{y}Co_{1-x-y}O₂, and related materials.

### Example 2. Lithium-ion Battery Recycling Technology with Organic Solutions of Aluminum Chloride

In Example 2, AlCl₃ solutions in ethanol (EtOH—AlCl₃) is used for lithium-ion battery cathode material recycling. Here, 10 wt. % of AlCl₃ (98.5%, anhydrous powder, Thermo Fisher Scientific) was slowly added to 10 ml of ethanol (≥99.5%, 200 proof, anhydrous, Sigma-Aldrich) while keeping the solution cold inside an argon filled glove box (H₂O and O₂<0.1 ppm). Then, LiCoO₂ or LiNi_{0.6}Mn_{0.2}Co_{0.2}Co_{0.2}(NMC622) with a molar ratio of 2:1 (Al: LiCoO₂ or NMC622) was added to the EtOH—AlCl₃ solution. The sample was heated at 75° C. for 12 h with a condenser on top (10° C.). LiCoO₂ or NMC622 is completely dissolved during the reaction.

The EtOH—AlCl₃ solution and the solutions after the reaction with LiCoO₂ or NMC622 were characterized with a number of methods. The liquid state ²⁷Al and ¹H NMR spectra were obtained by a Bruker Avance 600 spectrometer. The spectrometer was operating at 104.26 and 600.13 MHz for 27Al and 1H nuclei, respectively with a 14.1 T narrow bore superconducting magnet carried out with radio frequency field strengths of 20.8 kHz and 26 kHz, respectively and all the spines relaxed back to the thermal equilibrium at a recycle delay of 12.0 s. No standard solution was used in the experiments and all the signals were detected in room temperature.

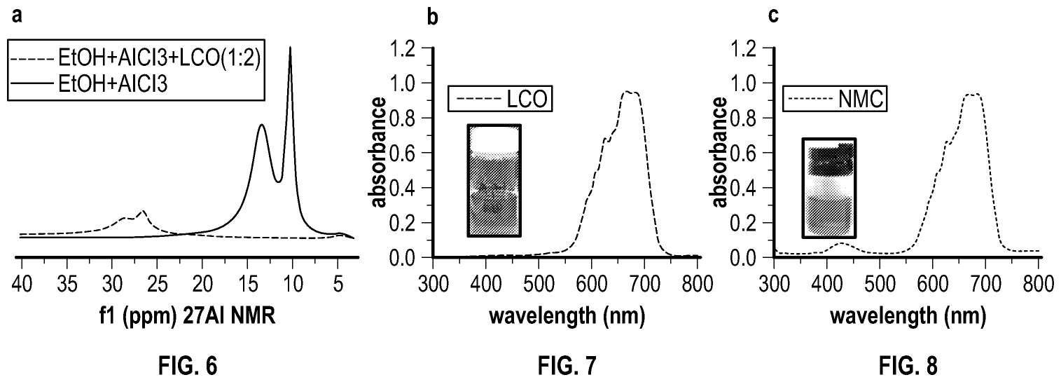

The ²⁷Al nuclear magnetic resonance (NMR) spectrum (FIG. 6) on the EtOH—AlCl₃ (10 wt. % of AlCl₃) solution at room temperature clearly show the two distinct signals at 9.8 and 12.8 ppm which are assigned to [AlCl(EtOH)₅]²⁺ and [AlCl₂(EtOH)₄]⁺ cations, respectively. When LiCoO₂ (molar ratio of Co/Al is 1:2) was completely dissolved in the solution at 75° C. after 12 h, no new ²⁷Al NMR peak is observed (FIG. 6) except that the [AlCl(EtOH)₅]²⁺ and [AlCl₂(EtOH)₄]⁺ peaks are shifted down filed due to the magnetic effect from the dissolved Co(II) cations.

An Agilent Cary 60 UV-Vis spectrophotometer was employed for UV-Visible spectroscopy. The spectrum of the pristine EtOH—AlCl₃ solution in a range of 350 to 750 nm was used as the baseline measurement. The solutions after the reactions with NMC622 or LiCoO₂ were diluted with the EtOH—AlCl₃ solution for UV-Vis measurement. The samples were contained in a 10×10 mm quart cuvette sealed with a plastic cap.

The existence of Co(II) cations is evidenced by the UV-Vis spectrum of the solution after reaction with LiCoO₂ as shown in FIG. 7. The Spectrum shows the characteristic peaks of cobalt tetrachloride anions (CoCl₄²⁻), and the inset of the FIG. 7 display the picture of the cobalt blue colored solution. Same dissolution behavior of NMC622 in EtOH—AlCl₃ is also observed under the identical reaction condition. FIG. 8 shows the UV-Vis spectrum of the solution after NMC622 dissolved, and it shows the characteristic peaks of CoCl₄²⁻ and NiCl₄²⁻ anions. The MnCl₄²⁻ anion does not absorb in the UV-Vis range. The inset of FIG. 8 is the photo of the NMC622 solution in EtOH—AlCl₃, which displays the characteristic green color of Ni(II). After the reaction completed, ethanol was evaporated and collected with rotary evaporation to obtain blue (from LiCoO₂) and green (NMC622) powder. Rotary evaporation of ethanol was carried out with a rotation speed of 120 rpm, and temperature of 80° C. under vacuum.

The crystal structure of the powder was identified using X-ray powder diffraction measurement (XRD) utilizing a Panalytical Empyrean Series 2. All the samples were dried at 80° C. in vacuum for 12 h inside an argon filled glove box. Then, the dried powders were pressed on a zero-diffraction silicon plate to form a flat pallet. The surface was sealed with Kapton tape to avoid contact with air and moisture. The scan range was from 10 to 900 with a 0.013° step size and a time per step of 148.92 s.

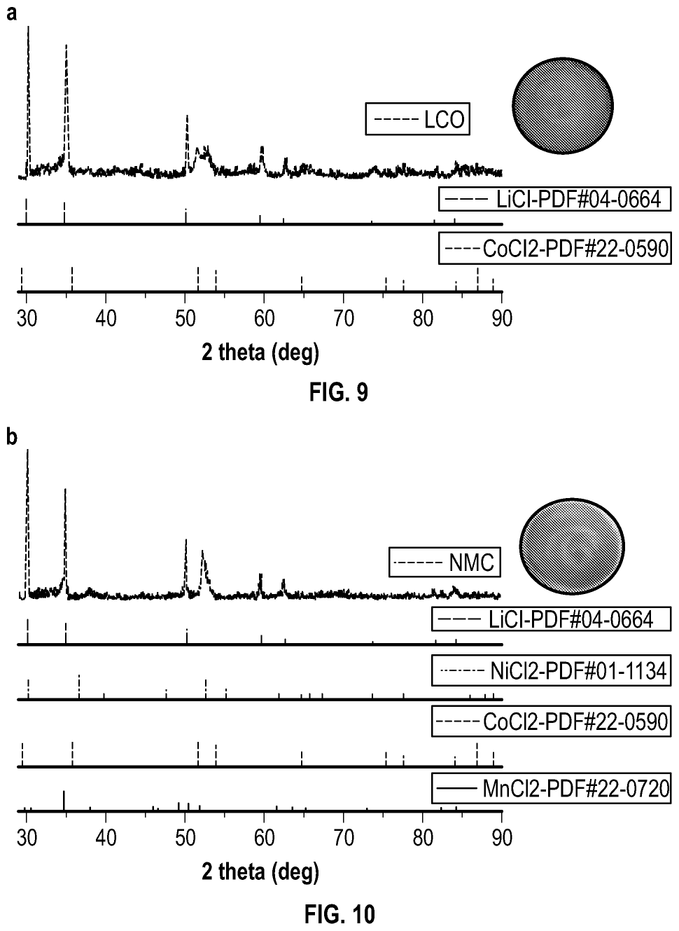

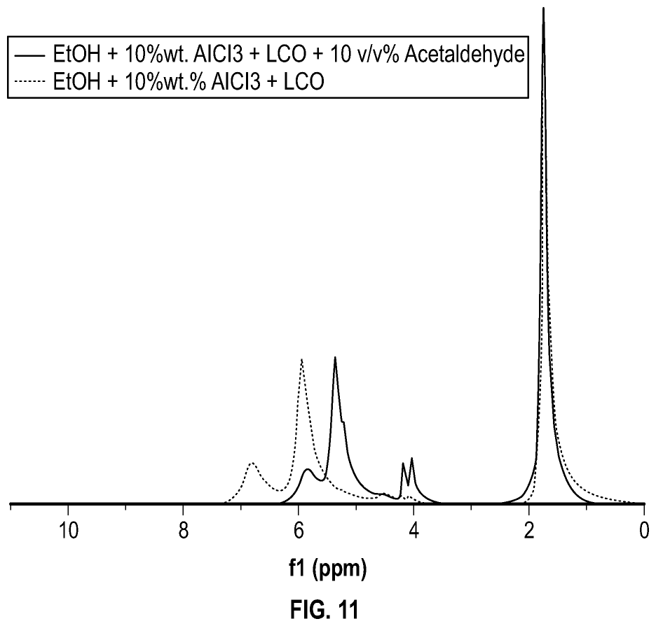

The X-ray diffraction (XRD) pattern of the blue powder (from LiCoO₂) in FIG. 9 clearly indicates the content of lithium chloride (LiCl) and cobalt(II) chloride (COCl₂). FIG. 10 displaying the XRD pattern of the green powder (from NMC622) indicates the content of LiCl, CoCl₂, nickel(II) chloride (NiCl₂), and manganese(II) chloride (MnCl₂). The analyses above indicate that the transition metals in the cathode materials are reduced from M(III) to M(II).

Oxygen gas tests were performed on the samples. Here, Oxygen gas was identified using a 100 g EtOH—AlCl₃ batch with the LiCoO₂ molar ratio of 2:1=Al:Co which was sealed and closed inside a glovebox with O₂<0.01 ppm. Gas test does not detect the generation of oxygen gas; therefore it is unlikely that the oxide in the cathodes is the reducing reagent.

A possible reducing reagent is ethanol, which is known can be reduced to acetaldehyde. Additional NMR characterization was done to follow up on this. FIG. 11 shows the ¹H NMR of the EtOH—AlCl₃ after complete dissolution of LiCoO₂ (dotted line). To identify acetaldehyde as a reaction product, ¹H NMR spectrum was also obtained from the same solution added with 10 vol. % anhydrous acetaldehyde (solid line in FIG. 11). The comparison proves the formation of acetaldehyde after the reaction as indicated by the doublet at 4 ppm.

Based on the analysis above, following reaction mechanism between EtOH—AlCl₃ and LiCoO₂ is proposed using AlCl₂⁺ and AlCl²⁺ as the representative active species:

2AlCl₂⁺2LiCoO₂+CH₃CH₂OH →2Li⁺+2Co²⁺+4Cl⁻+Al₂O₃+CH₃COH+H₂O

### OR

2AlCl²⁺+2LiCoO₂+CH₃CH₂OH →2Li⁺+2Co²⁺+2Cl⁻+Al₂O₃+CH₃COH+H₂O

NMC622 follows the same reaction mechanism.

Efficiency of the leaching and purification steps were measured through Inductively coupled plasma optical emission spectrometry (ICP-OES) by measuring the amount of aluminum (Al), cobalt (Co), and lithium (Li) utilizing a Perkin-Elmer Optima 7300DV ICP-OES apparatus. A known amount (mg) of the sample was dissolved in a highly acidic solution then the volume was brought up to 100 ml.

The ICP-OES measurement indicates that the Al content in the blue powder from LiCoO₂ can be readily removed via water rinsing and filtration after heat treatment at 150° C. The heated powder was mixed in deionized water and then pink transparent supernatant and white precipitate can be separated. The elemental analysis with ICP-OES of the supernatant and precipitate is listed in Table 2.

TABLE 2
Percentage of metals in the final products
after lithium and cobalt extraction.

| | Al (%) | cobalt (%) | lithium (%) |
|---|---|---|---|
| Supernatant | 4.46 ± 0.05 | 99.48 ± 0.03 | 49.76 ± 0.13 |
| Precipitate | 95.53 ± 0.05 | 0.52 ± 0.03 | 50.24 ± 0.13 |

These results demonstrate that EtOH—AlCl₃ is able to extract the cathode active materials with high efficiency, low temperature, and no emission. When compared with the hydrometallurgical processes, extremely acidic solutions (pH below zero) were utilized for increasing the leaching efficiency along with the addition of a reducing agent such as H₂O₂. Here the low acidity of the solution proposed indicates the importance of the aluminum complexes in the extraction of transition metals without any requirement for introducing H₂O₂ to the system since ethanol is acting as a reducing agent. Including primary aliphatic alcohols, the method is universal to all other solvents which form any kind of AlClₙ⁽³⁻ⁿ⁾(where n=4, 3, 2, and 1) ion when dissolving AlCl₃. For instance, AlCl₃ in diglyme and tetraglyme forms AlCl₄⁻ anion and AlCl₂ cation or in Tetrahydrofuran (THF), aluminum complexes such as AlCl₃(THF)₂ along with AlCl₄⁻, [AlCl₂(THF)₄]⁺ and [AlCl(THF)₅]²⁺ are formed. All these AlCl₃ solutions show a high leaching efficiency for cathode materials. This new type of extraction reagents composed of AlCl₃ in organic solvents can be used to recycle spent Li-ion batteries with any type of lithium transition metal oxide cathodes.

The terms and expressions that have been employed are used as terms of description and not of limitation, and there is no intention in the use of such terms and expressions of excluding any equivalents of the features shown and described or portions thereof, but it is recognized that various modifications are possible within the scope of the examples of the present disclosure. Thus, it should be understood that although the present disclosure has been specifically disclosed by specific examples and optional features, modification and variation of the concepts herein disclosed may be resorted to by those of ordinary skill in the art, and that such modifications and variations are considered to be within the scope of examples of the present disclosure.

### ADDITIONAL EXAMPLES

The following exemplary examples are provided, the numbering of which is not to be construed as designating levels of importance:

Example 1 is a method of recycling a lithium-ion battery cathode material, the method comprising reducing the lithium-ion battery cathode material with an ionic liquid including chloroaluminate anion and separating materials from the lithium-ion battery cathode.

In Example 2, the subject matter of Example 1 optionally includes wherein the ionic liquid comprises Lewis neutral chloroaluminate anions.

In Example 3, the subject matter of any one or more of Examples 1-2 optionally include wherein the ionic liquid comprises tetrachloroaluminate anions.

In Example 4, the subject matter of any one or more of Examples 1-3 optionally include wherein the ionic liquid comprises an organic solution of aluminum chloride.

In Example 5, the subject matter of any one or more of Examples 1-4 optionally include -methylimidazolium tetrachloroaluminate ionic liquid to the lithium-ion battery cathode material.

In Example 6, the subject matter of any one or more of Examples 1-5 optionally include wherein reducing the lithium-ion battery cathode material comprises adding tetrachloroaluminate ionic liquid to the lithium-ion battery cathode material.

In Example 7, the subject matter of any one or more of Examples 1-6 optionally include 1:2 molar ratio.

In Example 8, the subject matter of any one or more of Examples 1-7 optionally include 1:10 molar ratio.

In Example 9, the subject matter of any one or more of Examples 1-8 optionally include 1:50 molar ratio.

In Example 10, the subject matter of any one or more of Examples 1-9 optionally include solution to the lithium-ion battery cathode material.

In Example 11, the subject matter of any one or more of Examples 1-10 optionally include separating materials from the lithium-ion battery cathode comprises separating and removing cobalt from the lithium-ion battery cathode.

In Example 12, the subject matter of any one or more of Examples 1-11 optionally include separating materials from the lithium-ion battery cathode comprises separating and removing lithium from the lithium-ion battery cathode.

In Example 13, the subject matter of any one or more of Examples 1-12 optionally include wherein separating materials from the lithium-ion battery cathode comprises centrifuge.

In Example 14, the subject matter of any one or more of Examples 1-13 optionally include wherein separating materials from the lithium-ion battery cathode comprises extracting cobalt as a cation.

In Example 15, the subject matter of any one or more of Examples 1-14 optionally include wherein separating materials from the lithium-ion battery cathode comprises extracting cathode active materials.

In Example 16, the subject matter of any one or more of Examples 1-15 optionally include wherein separating materials from the lithium-ion battery cathode comprises extracting cathode active materials with no emissions.

In Example 17, the subject matter of any one or more of Examples 1-16 optionally include wherein separating materials from the lithium-ion battery cathode comprises extracting cathode active materials at room temperature.

In Example 18, the subject matter of any one or more of Examples 1-17 optionally include preparing the ionic liquid including chloroaluminate anion prior to reducing the lithium-ion battery cathode material.

In Example 19, the subject matter of Example 18 optionally includes mixing AlCl₃ in EMIMCl with a molar ratio of 1:1

In Example 20, the subject matter of any one or more of Examples 18-19 optionally include powder to EMIMCl.

In Example 21, the subject matter of any one or more of Examples 18-20 optionally include to ethanol.

What is claimed is:

1. A method of recycling a battery cathode material, the method comprising reducing the battery cathode material with a liquid including chloroaluminate ions and separating materials from the battery cathode material.

2. The method of claim 1, wherein the liquid including chloroaluminate ions comprises an ionic liquid with Lewis neutral chloroaluminate anions.

3. The method of claim 1, wherein the liquid including chloroaluminate ions comprises an ionic liquid with tetrachloroaluminate anions.

4. The method of claim 1, wherein the liquid including chloroaluminate ions comprises an organic solution of aluminum chloride.

5. The method of claim 1, wherein reducing the battery cathode material comprises adding 1-Ethyl-3-methylimidazolium tetrachloroaluminate ionic liquid to the battery cathode material.

6. The method of claim 1, wherein reducing the battery cathode material comprises adding tetrachloroaluminate ionic liquid to the battery cathode material.

7. The method of claim 1, wherein reducing the cathode material comprises adding tetrachloroaluminate ionic liquid to the cathode material at a 1:2 molar ratio.

8. The method of claim 1, wherein reducing the cathode material comprises adding tetrachloroaluminate ionic liquid to the cathode material at a 1:10 molar ratio.

9. The method of claim 1, wherein reducing the cathode material comprises adding tetrachloroaluminate ionic liquid to cathode material at a 1:50 molar ratio.

10. The method of claim 1, wherein reducing the cathode material comprises adding EtOH—AlCl₃ solution to the battery cathode material.

11. The method of claim 1, separating materials from the battery cathode material comprises separating and removing cobalt from the battery cathode material.

12. The method of claim 1, separating materials from the battery cathode material e comprises separating and removing lithium from the battery cathode material.

13. The method of claim 1, wherein separating materials from the battery cathode material further comprises centrifuge.

14. The method of claim 1, wherein separating materials from the battery cathode material comprises extracting cobalt as a cation.

15. The method of claim 1, wherein separating materials from the battery cathode material comprises extracting cathode active materials.

16. The method of claim 1, wherein separating materials from the battery cathode material comprises extracting cathode active materials with no emissions.

17. The method of claim 1, wherein separating materials from the battery cathode material comprises extracting cathode active materials at room temperature.

18. The method of claim 1, further comprising preparing the liquid including chloroaluminate ions prior to reducing the lithium-ion battery cathode material.

19. The method of claim 18, wherein preparing the liquid including chloroaluminate ions comprises mixing AlCl₃ in EMIMCl with a molar ratio of 1:1.

20. The method of claim 18, wherein preparing the liquid including chloroaluminate ions comprises gradually adding anhydrous AlCl₃ powder to EMIMCl.

21. The method of claim 18, wherein preparing the liquid including chloroaluminate ions comprises adding anhydrous AlCl₃ to ethanol.
